(19) United States
(12) Patent Application Publication
(10) Pub. No.: US 2009/0055263 A1
(43) Pub. Date: Feb. 26, 2009

(54) PROMOTING SHOPPING INFORMATION ON A NETWORK BASED SOCIAL PLATFORM

(75) Inventors: Trisha Lee Okubo, San Jose, CA (US); Yuan Der Ho, San Mateo, CA (US); Choon Chong, San Francisco, CA (US); Rolf Skyberg, Campbell, CA (US); Massimiliano Mancini, San Jose, CA (US); Adam Trachtenberg, San Francisco, CA (US); Philip Law, Sunnyvale, CA (US)

Correspondence Address: SCHWEGMAN, LUNDBERG & WOESSNER/EBAY, P.O. BOX 2938, MINNEAPOLIS, MN, 55402, US

(73) Assignee: eBay Inc., San Jose, CA (US)

(21) Appl. No.: 11/963,464

(22) Filed: Dec. 21, 2007

Related U.S. Application Data
(60) Provisional application No. 60/957,645, filed on Aug. 23, 2007.

(51) Int. Cl. G06Q 30/00

(52) U.S. Cl. 705/14

(57) ABSTRACT

A system for promoting shopping information on a social networking platform. At the social networking platform, the system receives a request from a first user of the network-based social platform to request a second user of the network-based social platform to accept an agreement to facilitate promotion of an advertisement in association with the second user on the network-based social platform. The advertisement facilitates a sale of at least one item offered for sale by the first user on a network-based marketplace. Next, the system receives of an acceptance of the agreement from the second user to facilitate promotion of the advertisement in association with the second user on the network-based social platform. Finally, the system promotes the advertisement in association with the second user on the network-based social platform.

### RELATED APPLICATIONS

This application claims the priority benefits of U.S. Provisional Application No. 60/957,645, filed Aug. 23, 2007 which is incorporated herein by reference.

### FIELD

Embodiments relate generally to the technical field of data communications and, in one example embodiment, communications over a network.

### BACKGROUND

Applications available on the Internet have progressed from facilitating a medium of information delivery to a venue for sales and more recently to a platform for social networking. Online market places such as Amazon.com and eBay.com are examples of online sellers. Similarly, mySpace.com and Facebook.com are examples of social networking.

### BRIEF DESCRIPTION OF DRAWINGS

The present disclosure is illustrated by way of example and not limitation in the figures of the accompanying drawings, in which like references indicate similar elements and in which:

FIG. 1 is a network diagram depicting a system, according to one example embodiment, having a client-server architecture;

FIG. 2 is a block diagram illustrating social applications, according to an embodiment;

FIG. 3 is a block diagram illustrating a database, according to an embodiment;

FIG. 4 is a block diagram illustrating marketplace and payment applications, according to an embodiment;

FIG. 5 is a high-level entity-relationship diagram, illustrating various tables stored on a database(s);

FIG. 6 is a block diagram illustrating a user table, according to an embodiment;

FIG. 7 is a block diagram illustrating an item table, according to an embodiment;

FIG. 8 is a block diagram illustrating a method, according to an embodiment, to promote shopping information;

FIG. 9 is a block diagram illustrating a method, according to an embodiment, to promote shopping information;

FIG. 10 is a block diagram illustrating a method, according to an embodiment, to receive a selection that results in a sale of an item;

FIGS. 11-13 are diagrams illustrating user interfaces, according to an embodiment; and

FIG. 14 is a block diagram of a machine, according to an example embodiment, including instructions to perform any one or more of the methodologies described herein.

### DETAILED DESCRIPTION

In the following description, for purposes of explanation, numerous specific details are set forth in order to provide a thorough understanding of an embodiment of the present disclosure. It will be evident, however, to one skilled in the art that the present disclosure may be practiced without these specific details.

In some example embodiments, a system and method for promoting shopping information on a network-based social platform is illustrated. In one embodiment, the network-based social networking platform may receive a request from a first user of the network-based social platform to communicate a request to a second user of the network-based social platform. The request may be for the second user to accept of an agreement between the first and second users to facilitate promotion of an advertisement in association with the second user on the network-based social platform. For example, the second user may be associated with user interfaces on which the advertisement of the first user may be promoted. In one embodiment, the agreement may include an affiliate agreement whereby the second user promises to promote the advertisement to facilitate a sale of the item offered for sale by the first user on a network-based marketplace and the first user promises to compensate the second user responsive to sale of the item. In another embodiment, the agreement may not result in a compensation paid to the second user. In response to acceptance of the agreement from the second user, the advertisement may be promoted on the network-based social platform in association with the second user. Responsive to receipt of a selection based on the advertisement that results in a sale of the item, compensation may be paid to the second user.

### Platform Architecture

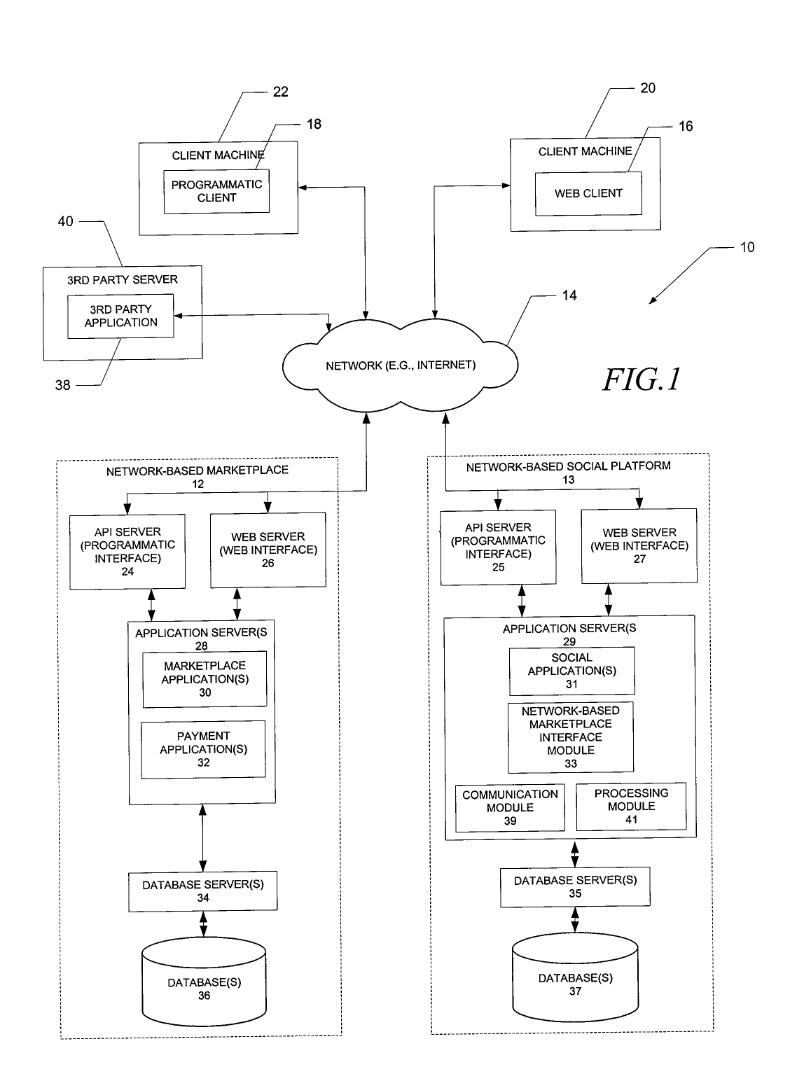

FIG. 1 is a network diagram depicting a system 10, according to one embodiment of the present disclosure, having a client-server and a peer-to peer architecture. The system 10 facilitates shopping activity, in the exemplary form of a network-based marketplace 12, and a network-based social platform 13 that communicate over a network 14. In one embodiment, the network-based marketplace 12 and the network-based social platform 13 communicate in peer-to peer architecture via programmatic interfaces. Further, the network-based marketplace 12 and the network-based social platform 13 respectively communicate in client-server architecture with clients. The network-based marketplace 12, provides server-side functionality, via the network 14 (e.g., the Internet), to the one or more client machines 20 and 22. Similarly, the network-based social platform 13 provides server-side functionality, via the network 14 (e.g., the Internet), to the one or more client machines 20 and 22. FIG. 1 illustrates, for example, a web client 16 (e.g., a browser, such as the Internet Explorer browser developed by Microsoft Corporation of Redmond, Wash.), and a programmatic client 18 executing on respective client machines 20 and 22.

Turning specifically to the network-based social platform 13, an application program interface (API) server 25 and a web server 27 are coupled to, and provide programmatic and web interfaces respectively to, one or more application servers 29. The application servers 29 may host one or more social applications 31 and a network-based marketplace interface module 33 that communicates with a communication module 39 and a processing module 41. The application servers 28 are, in turn, shown to be coupled to one or more databases servers 35 that facilitate access to one or more databases 37.

The social applications 31 provide a number of social networking functions and services to users that access the network-based social platform 13. For example, the social applications 31 may enable a user to store information in a profile that may be viewed at the client machines 20, 22 and to selectively grant access to information that appears on the profile to other users who may also view the profile at their client machines 20, 22. The social applications 31 may provide criteria that may be employed by a user to grant various levels of access to various levels of users. For example, a first user may access profile information associated with a second user responsive to the first user achieving the status of “friend” in relation to a second user. A user may achieve the status of “friend” by accepting an invitation from another user or by sending a request to a user who subsequently grants the request.

The social applications 31 may further enable third party service providers to add “applications” on the network-based social platform 13 that are utilized by users to interact with other users. For example, a network-based marketplace application may be added by a third party service provider in the form of the network-based marketplace interface module 33, the communication module 39, and the processing module 41 that may provide market application services in the network-based social platform 13 environment and may communicate with the network-based marketplace 12.

In one embodiment, a request related to the marketplace application may be generally processed as follows. The request may originate at the client machines 20, 22 that communicates the request via programmatic or web interface services 25, 27 to the social applications 31 that, in turn, communicate the request to the network-based marketplace interface module 33 that, in turn, communicates the request to the communication module 39 and processing module 41 that process the request. Conversely, the communication module 39 and processing module 41 may respond to the social applications 31 via the network-based marketplace interface module 33. In some instances processing of the request may require communication with the network-based marketplace 12. In such instances the communication module 39 or processing module 41 may communicate via the API interface 25 with the network-based marketplace 12.

The network-based social platform 13 may be embodied as FACEBOOK® services, a social utility that connects people with friends and others who work, study and live around them provided by Facebook of Palo Alto, Calif.

The web client 16, it will be appreciated, accesses the various social applications 31 via the web interface supported by the web server 27. Similarly, the programmatic client 18 accesses the various services and functions provided by the social applications 31 via the programmatic interface provided by the API server 25.

Turning to the network-based marketplace 12, an application program interface (API) server 24 and a web server 26 are coupled to, and provide programmatic and web interfaces respectively to, one or more application servers 28. The application servers 28 host one or more marketplace applications 30 and payment applications 32. The application servers 28 are, in turn, shown to be coupled to one or more databases servers 34 that facilitate access to one or more databases 36.

The marketplace applications 30 provide a number of marketplace functions and services to users that access the marketplace 12. The payment applications 32 likewise provide a number of payment services and functions to users. The payment applications 32 may allow users to qualify for, and accumulate, value (e.g., in a commercial currency, such as the U.S. dollar, or a proprietary currency, such as “points”) in accounts, and then later to redeem the accumulated value for products (e.g., goods or services) that are made available via the marketplace applications 30.

While the marketplace and payment applications 30 and 32 are shown in FIG. 1 to both form part of the network-based marketplace 12, it will be appreciated that, in alternative embodiments of the present disclosure, the payment applications 32 may form part of a payment service that is separate and distinct from the marketplace 12. The network-based marketplace 12 may be embodied as eBAY, the worlds online marketplace, provided by eBay of San Jose, Calif.

Further, while the system 10 shown in FIG. 1 employs a client-server architecture and a peer-to-peer architecture, the present disclosure is of course not limited to such an architecture, and could equally well find application in any combination of client-server, distributed, or peer-to-peer, architecture systems. The various marketplace and payment applications 30 and 32 could also be implemented as standalone software programs, which do not necessarily have networking capabilities.

The web client 16, it will be appreciated, accesses the various marketplace and payment applications 30 and 32 via the web interface supported by the web server 26. Similarly, the programmatic client 18 accesses the various services and functions provided by the marketplace and payment applications 30 and 32 via the programmatic interface provided by the API server 24. The programmatic client 18 may, for example, be a seller application (e.g., the TurboLister application developed by eBay Inc., of San Jose, Calif.) to enable sellers to author and manage listings of items on the marketplace 12 in an off-line manner, and to perform batch-mode communications between the programmatic client 18 and the network-based marketplace 12.

It will be appreciated that the marketplace applications 30, payment applications 32, social applications 31, the network-based marketplace interface module 33, the communication module 39 and the processing module 41 may execute on a single platform. Accordingly, in one embodiment, the aforementioned applications/modules may execute on the network-based marketplace 12 and in another embodiment the aforementioned applications/module may execute on the network-based social platform 13.

FIG. 1 also illustrates a third party application 38, executing on a third party server machine 40, as having programmatic access to the network-based marketplace 12 via the programmatic interface provided by the API server 24. For example, the third party application 38 may, utilizing information retrieved from the network-based marketplace 12, support one or more features or functions on a website hosted by the third party. The third party website may, for example, provide one or more promotional, marketplace or payment functions that are supported by the relevant applications of the network-based marketplace 12.

### Social Platform Applications

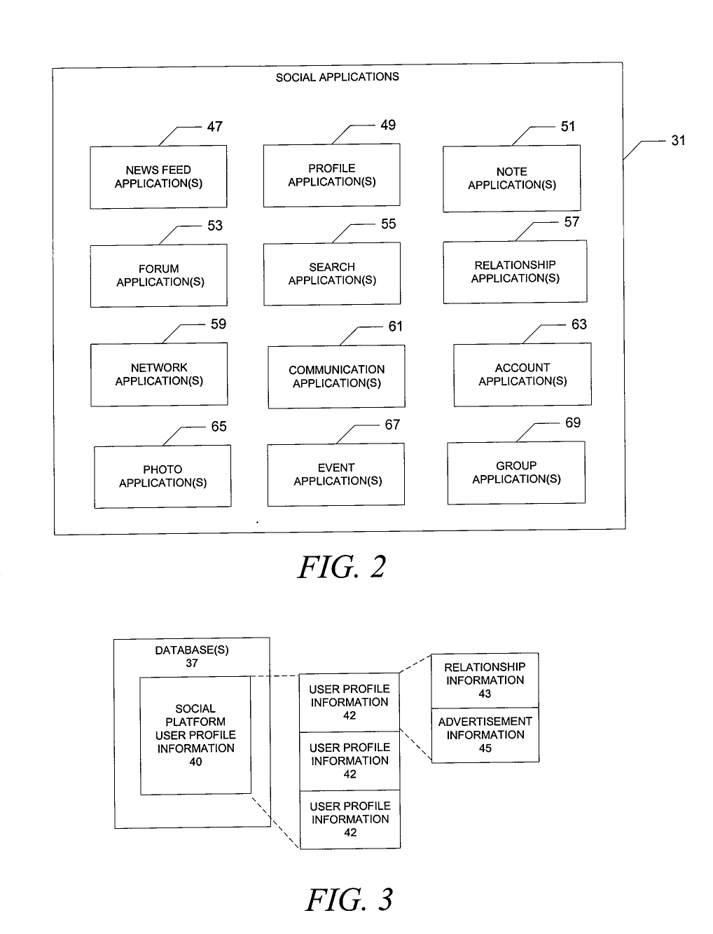

FIG. 2 is a block diagram illustrating social applications 31 that execute on the network-based social platform 13, according to an embodiment. The social applications 31 include news feed applications 47, profile applications 49, note applications 51, forum applications 53, search applications 55, relationship applications 57, network applications 59, communication applications 61, account applications 63, photo applications 65, event applications 67 and group applications 69.

The news feed applications 47 publish events associated users on the network-based social platform 13. The news feed applications 47 may publish the events on the user profile of a user. For example, the news feed applications 47 may publish the uploading of a photo album by one user on the user profile the user and the user profiles of friends of the user.

The profile applications 49 may maintain user profiles for each of the users on the network-based social platform 13. Further, the profile applications 49 may enable a user to restrict access to selected parts of their profile to prevent viewing by other users. The notes applications 51 may be used to author notes that may be published on various user interfaces.

The forum applications 53 may maintain forums for users to post comments, pictures, advertisements (e.g., content). For example, the forums may be located on a user profile of the user posting the content or the user profile of another user. The user may add content to the forum, remove content from the forum and restrict visibility of the content to other users. The search applications 55 may enable a user to perform a keyword search for users, groups, and events. In addition, the search applications 55 may enable a user to search for content on profiles accessible to the user.

The relationship applications 57 may maintain relationship information (e.g., affiliate relationship) for the users. The network applications 59 may facilitate the addition of social networks by a user. The social networks may be based on a school, workplace, or region or any social construct for which the user may prove an affiliation. The communication applications 61 may process incoming and outgoing messages, maintain an inbox for each user, facilitate sharing of content, facilitate interaction among friends (e.g., poking), process requests, process events, process group invitations and process communicating notifications.

The account applications 63 may provide services to facilitate registering, updating, and deleting user accounts. The photo applications 65 may provide services to upload photographs, arrange photographs, set privacy options for albums and tag photographs with text strings. The event applications 67 provides services to create events, review upcoming events, and review past events. The group applications 69 may be used to maintain group information, display group information, and navigate to groups.

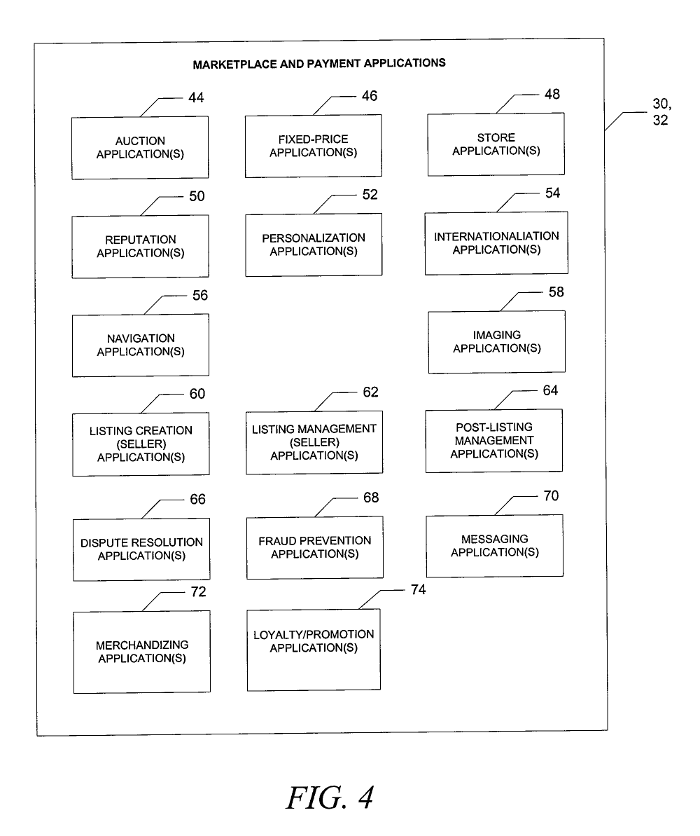

FIG. 3 is a block diagram illustrating a database 37, according to an embodiment, at a network-based social platform 13. The database 37 is shown to store user profile information 42 for each user on the network-based social platform 13. The user profile information 42 may store relationship information 43 and advertisement information 45. The relationship information 43 may store predetermined relationships between the identified user and other users on the network-based social platform 13. For example, a first user may be related to second user on the network-based social platform 13 as a “marketplace community member” or “friend,” or “favourite friend,” etc. The respective designations may correspond to an increasing levels of disclosure. Further for example, the first user may be related to second user on the network-based social platform 13 as an “affiliate.” The affiliate designation corresponds to a relationship in which one user has agreed to promote an advertisement for another user on the network-based social platform 13 and, in some embodiments, receive compensation for sales of items on the network-based marketplace 12 that results from the advertisement.

The advertisement information 45 may store advertisements that the user has agreed to promote on the network-based social platform 13. For example, the advertisement may include an advertisement for an item for sale, an advertisement for multiple items for sale, an advertisement of a store with items for sale, and an advertisement with a category that includes an item for sale.

### Marketplace and Payment Applications

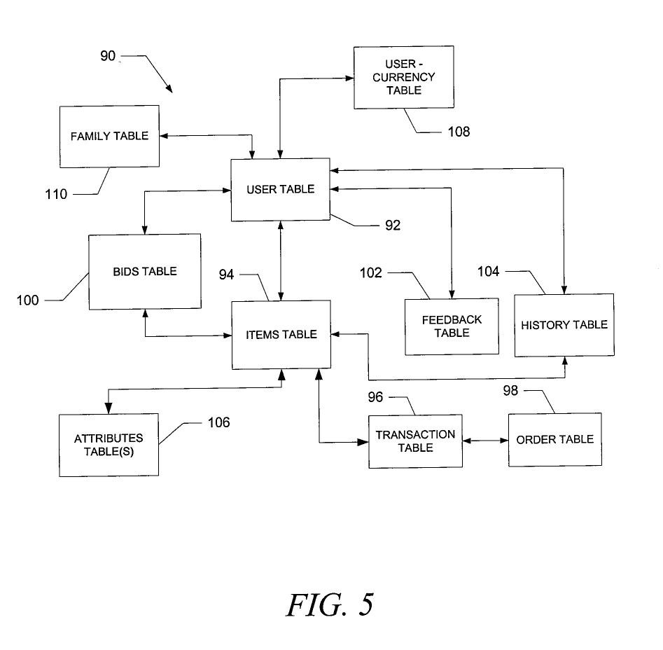

FIG. 4 is a block diagram illustrating multiple marketplace and payment applications 30, 32 that, in one exemplary embodiment of the present disclosure, are provided as part of the network-based marketplace 12. The marketplace 12 may provide a number of listing and price-setting mechanisms whereby a seller may list goods or services (e.g., items) for sale, a buyer can express interest in or indicate a desire to purchase such goods or services, and a price can be set for a transaction pertaining to the goods or services. To this end, the marketplace applications 30 are shown to include one or more auction applications 44 which support auction-format listing and price setting mechanisms (e.g., English, Dutch, Vickrey, Chinese, Double, Reverse auctions etc.). The various auction applications 44 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 46 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with an auction-format listing, and allow a buyer to purchase goods or services, which are also being offered for sale via an auction, for a fixed-price that is typically higher than the starting price of the auction.

Store applications 48 allow sellers to group their listings within a “virtual” store, which may be branded and otherwise personalized by and for the sellers. Such a virtual store may also offer promotions, incentives and features that are specific and personalized to a relevant seller.

Reputation applications 50 allow parties that transact utilizing the network-based marketplace 12 to establish, build and maintain reputations, which may be made available and published to potential trading partners. Consider that where, for example, the network-based marketplace 12 supports person-to-person trading, users may have no history or other reference information whereby the trustworthiness and credibility of potential trading partners may be assessed. The reputation applications 50 allow a user, for example through feedback provided by other transaction partners, to establish a reputation within the network-based marketplace 12 over time. Other potential trading partners may then reference such a reputation for the purposes of assessing credibility and trustworthiness.

Personalization applications 52 allow users of the marketplace 12 to personalize various aspects of their interactions with the marketplace 12. For example a user may, utilizing an appropriate personalization application 52, create a personalized reference page at which information regarding transactions to which the user is (or has been) a party may be viewed. Further, a personalization application 52 may enable a user to personalize listings and other aspects of their interactions with the marketplace 12 and other parties.

In one embodiment, the international applications 54 may support a number of marketplaces that are customized, for example, for specific geographic regions. A version of the marketplace 12 may be customized for the United Kingdom, whereas another version of the marketplace 12 may be customized for the United States. Each of these versions may operate as an independent marketplace, or may be customized (or internationalized) presentations of a common underlying marketplace.

Navigation of the network-based marketplace 12 may be facilitated by one or more navigation applications 56. For example, a search application enables key word searches of listings published via the marketplace 12. A browse application allows users to browse various category, catalogue, or inventory data structures according to which listings may be classified within the marketplace 12. Various other navigation applications may be provided to supplement the search and browsing applications.

In order to make listings, available via the network-based marketplace 12, as visually informing and attractive as possible, the marketplace applications 30 may include one or more imaging applications 58 utilizing which users may upload images for inclusion within listings. The imaging applications 58 may also operate to incorporate images within viewed listings. The imaging applications 58 may also support one or more promotional features, such as image galleries that are presented to potential buyers. For example, sellers may pay an additional fee to have an image included within a gallery of images for promoted items.

Listing creation applications 60 allow sellers conveniently to author listings pertaining to goods or services (e.g., items) that they wish to transact via the marketplace 12, and listing management applications 62 to allow sellers to manage such listings. Specifically, where a particular seller has authored and/or published a large number of listings, the management of such listings may present a challenge. The listing management applications 62 provide a number of features (e.g., auto-relisting, inventory level monitors, etc.) to assist the seller in managing such listings. One or more post-listing management applications 64 also assist sellers with a number of activities that typically occur post-listing. For example, upon completion of an auction facilitated by one or more auction applications 44, a seller may wish to leave feedback regarding a particular buyer. To this end, the post-listing management application 64 may provide an interface to one or more reputation applications 50, so as to allow the seller conveniently to provide feedback regarding multiple buyers to the reputation applications 50. In addition, the post listing management applications 64 may facilitate tracking and organization of listings for a user by maintaining identified listings in lists.

Dispute resolution applications 66 provide mechanisms whereby disputes arising between transacting parties may be resolved. For example, the dispute resolution applications 66 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 68 implement various fraud detection and prevention mechanisms to reduce the occurrence of fraud within the marketplace 12.

Messaging applications 70 are responsible for the generation and delivery of messages to users of the network-based marketplace 12, such messages for example advising users regarding the status of listings at the marketplace 12 (e.g., providing “outbid” notices to bidders during an auction process or to provide promotional and merchandising information to users).

Merchandising applications 72 support various merchandising functions that are made available to sellers to enable sellers to increase sales via the marketplace 12. The merchandising applications 72 also operate the various merchandising features that may be invoked by sellers, and may monitor and track the success of merchandising strategies employed by sellers.

The network-based marketplace 12 itself, or one or more parties that transact via the marketplace 12, may operate loyalty programs that are supported by one or more loyalty/promotions applications 74. For example, a buyer may earn loyalty or promotions points for each transaction established and/or concluded with a particular seller, and be offered a reward for which accumulated loyalty points can be redeemed.

### Data Structures

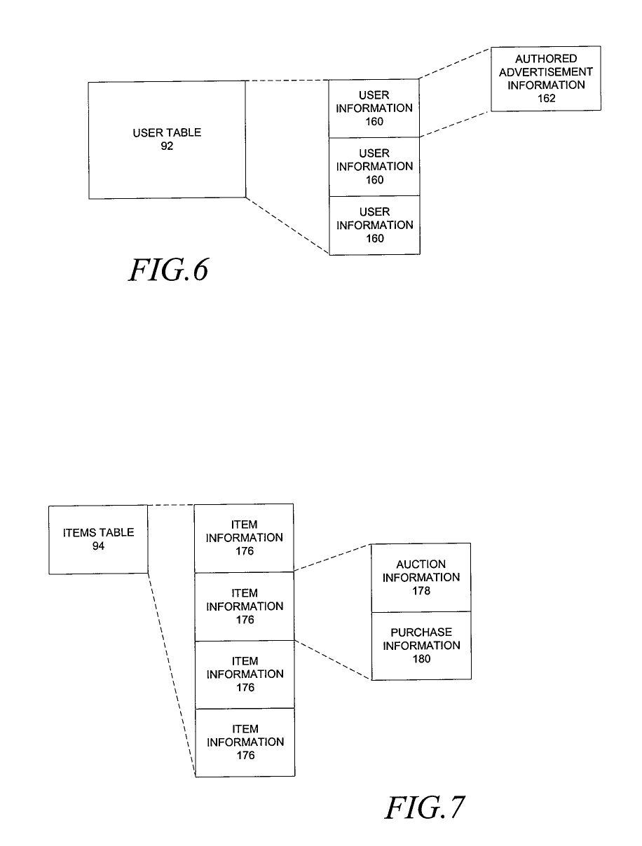

FIG. 5 is a high-level entity-relationship diagram, illustrating various tables 90 that may be maintained within the databases 36, and that are utilized by and support the marketplace and payment applications 30 and 32. A user table 92 contains a record for each registered user of the network-based marketplace 12, and may include identifier, address and financial instrument information pertaining to each such registered user. A user may, it will be appreciated, operate as a seller, a buyer, or both, within the network-based marketplace 12. In one exemplary embodiment of the present disclosure, a buyer may be a user that has accumulated value (e.g., commercial or proprietary currency), and is then able to exchange the accumulated value for items that are offered for sale by the network-based marketplace 12.

The tables 90 also include an items table 94 in which are maintained item records (e.g., item information) for goods and services that are available to be, or have been, transacted via the marketplace 12. Each item record within the items table 94 may furthermore be linked to one or more user records within the user table 92, so as to associate a seller and one or more actual or potential buyers with each item record.

A transaction table 96 contains a record for each transaction (e.g., a purchase transaction) pertaining to items for which records exist within the items table 94. An order table 98 is populated with order records, each order record being associated with an order. Each order, in turn, may be with respect to one or more transactions for which records exist within the transactions table 96.

Bid records within a bids table 100 each relate to a bid received at the network-based marketplace 12 in connection with an auction-format listing supported by an auction application 44. A feedback table 102 is utilized by one or more reputation applications 50, in one exemplary embodiment, to construct and maintain reputation information concerning users. In one embodiment, the reputation information may include feedback records associated with transactions. A history table 104 maintains a history of transactions to which a user has been a party. One or more attributes tables 106 record attribute information pertaining to items for which records exist within the items table 94. Considering only a single example of such an attribute, the attributes tables 106 may indicate a currency attribute associated with a particular item, the currency attribute identifying the currency of a price for the relevant item as specified in by a seller.

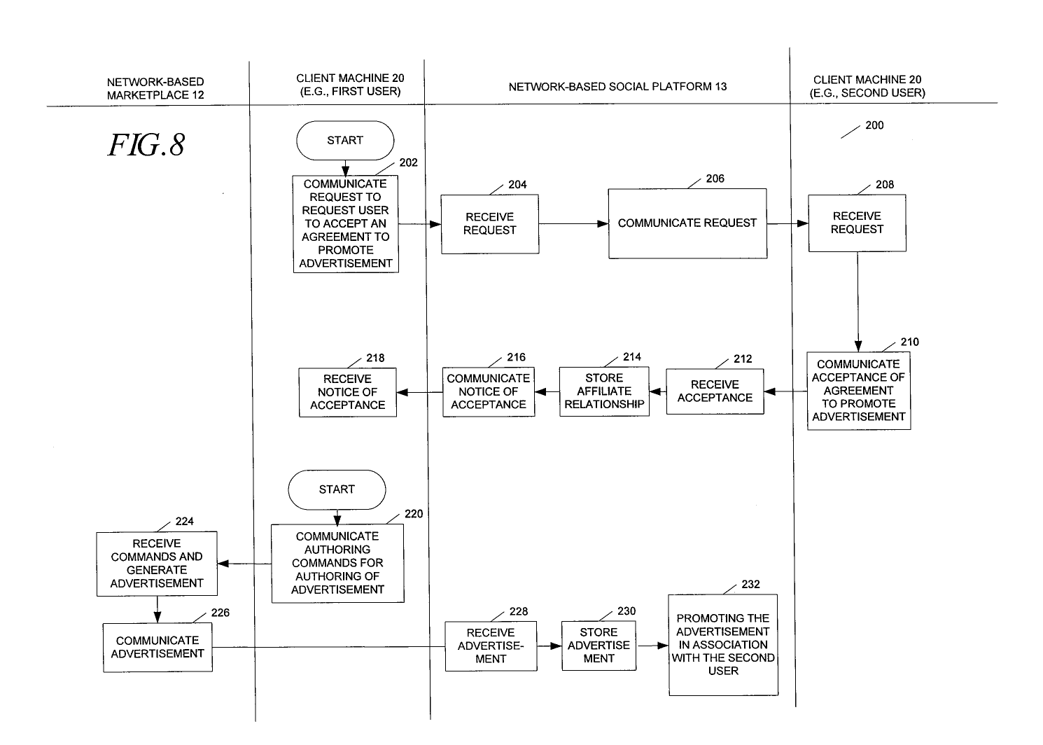

FIG. 6 is a block diagram illustrating a user table 92, according to an embodiment. The user table 92 includes a user information 160 for each user on the network-based marketplace 12. Each user information 160 may store authored advertisement information 162 that includes advertisements that have been authored by the user. The authored advertisement information 162 may be communicated to the network-based social platform 13 for promotion on the network-based social platform 13 in association with a user.

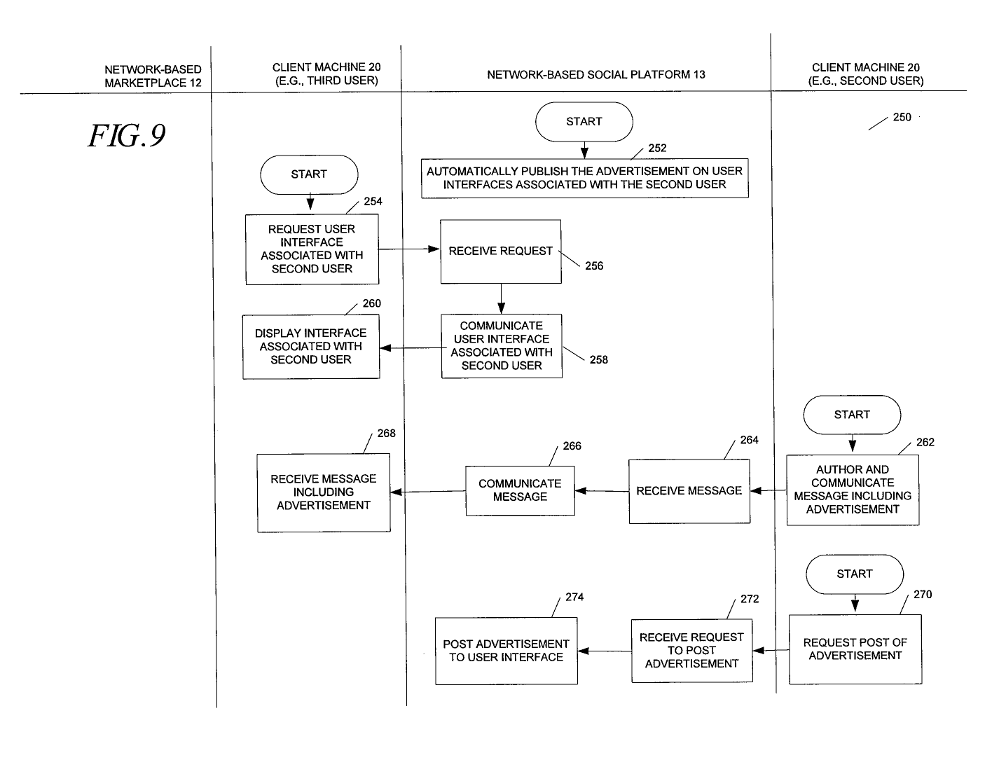

FIG. 7 is a block diagram illustrating an items table 94, according to an embodiment. The items table 94 stores item information 176 (e.g., listing information) for each item on the network-based marketplace 12. For example, the item information 176 may store a title, a description, a photograph, or any other information or content descriptive of goods or services that may be offered for sale on the network-based marketplace 12. The item information 176 is specifically shown to store auction information 178 and purchase information 180. The auction information 178 may store information related to the auctioning of the item (e.g., minimum bid, current bid, highest bid, start time of auction, end time of auction, etc.). The purchase information 180 may store information related to the purchase of the item (e.g., purchase price). In one embodiment, an item offered for sale on the network-based marketplace 12 may be acquired by submitting the highest bid in an auction or by paying a predetermined purchase price.

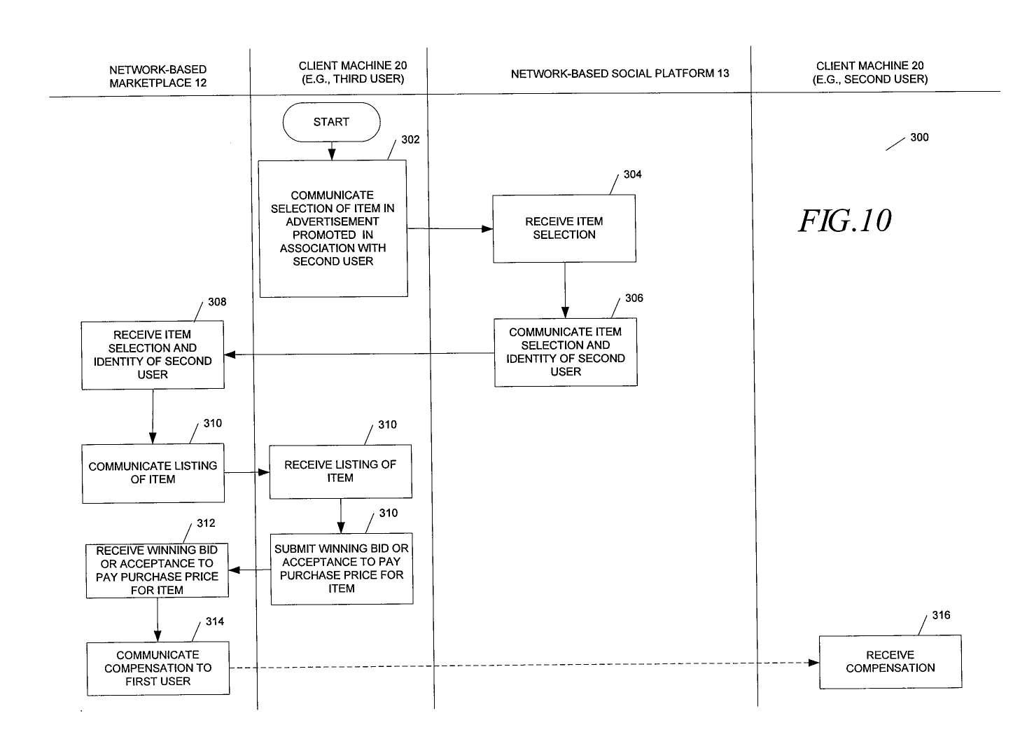

FIG. 8 is a block diagram illustrating a method 200, according to an embodiment, to promote shopping information in association with a user on a network-based social platform. Illustrated on the middle left may be operations performed on a client machine 20 associated with a first user and illustrated on the far right may be operations performed on a client machine 20 associated with a second user. Illustrated on the middle right may be operations performed on a network-based social platform 13 and illustrated on the far left may be operations performed on a network-based marketplace 12.

The method 200 may commence, at operation 202, with a first user on the network-based social platform requesting a second user on the network-based social platform 13 to enter into an affiliate relationship. Specifically, the first user may be requesting the second user of the network-based social platform 12 to accept an agreement to facilitate promotion of an advertisement. In one embodiment the second user may receive compensation from the first user for a sale of an item on the network-based marketplace that results from the advertisement.

When operation 202 is executed, the client machine 20 may receive the request from the first user and communicates the request to the network-based social platform 13.

At operation 204, the communication module 39, at the network-based social platform 13, may receive the request and at operation 206, the processing module 41 may communicate the request to the client machine 20 associated with the second user.

At operation 210, the client machine 20 associated with the second user receives the request and displays the request to the second user. At operation 210, the client machine 20 communicates an acceptance of the agreement to the network based social platform 13.

At operation 212, at the network-based social platform 13, the communication module 39 may receive the acceptance. At operation 214, the processing module 41 stores an affiliate relationship in the user profile information 42 of the first user for the second user and an affiliate relationship in the user profile information 42 of the second user for the first user based on the acceptance. At operation 216, the processing module 41 may communicate a notice of the acceptance of the agreement to enter an affiliate relationship to the client machine 20 associated with the first user and the process ends.

At operation 220, the client machine 20 associated with the first user communicates authoring commands to author an advertisement. For example, client machine 20 may communicate commands entered by the first user who may enter commands that select a listing of an item for sale on the network based marketplace, a background, and other graphics to create an advertisement. The listing may include item information 176 that further includes auction information 178 and/or purchase information 180. The user may select a user interface element to submit the advertisement causing the client machine 20 to communicate the authored advertisement to the network-based marketplace 12.

At operation 224, the network-based marketplace 12 generates the advertisement responsive to receiving the commands from the client machine 20. At operation 226, the network-based marketplace 12 may communicate an advertisement message including the advertisement, an identifier of the first user, and an identifier of the second user to the network-based social platform 13.

At operation 228, at the network-based social platform 13, the communication module 39 receives the advertisement message and at operation 230 the processing module 41 stores the advertisement in the advertisement information 45 associated with the second user. Other embodiments may store the advertisement in the advertisement information associated with the first user or both users. At operation 232, the processing module 41 promotes the advertisement in association with the second user. In the present example, an advertisement of an item for sale was promoted. In another example, the advertisement may feature multiple items for sale on the network-based marketplace 12, a virtual store on the network-based marketplace 12 that includes items for sale or a category on the network-based marketplace 12 that includes items for sale.

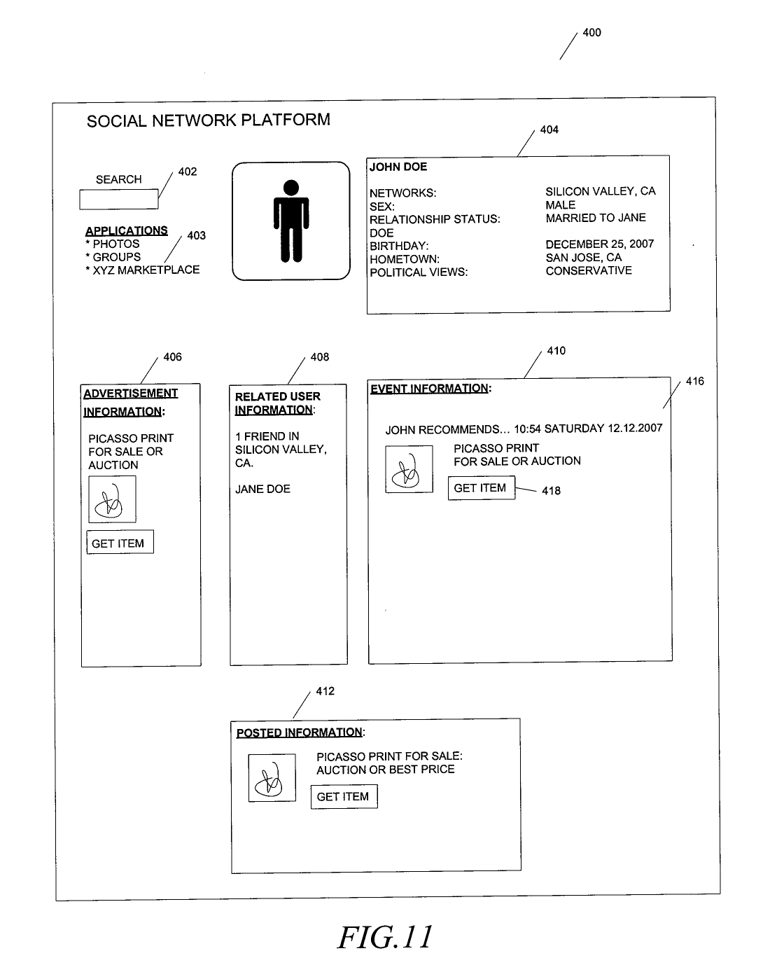

FIG. 9 is a block diagram illustrating a method 250, according to an embodiment, to promote shopping information. Illustrated on the middle left may be operations performed on a client machine 20 associated with a third user and illustrated on the far right may be operations performed on a client machine 20 associated with a second user. For example, the second user may have entered an affiliate relationship with a first user to promote an advertisement authored by the first user on the network-based social platform. Further for example, the third user may be a user on the network-based social platform 13 that views the advertisement and makes a selection based on the advertisement that results in a sale of item. Illustrated on the middle right may be operations performed on a network-based social platform 13 and illustrated on the far left may be operations performed on a network-based marketplace 12.

The method 250 corresponds to the method 232 on FIG. 8 The method 250 may commence at operation 252 with the processing module 41 automatically publishing the advertisement on user interfaces associated with the second user. For example, the processing module 41 may automatically publish the advertisement on an area of a profile (e.g., user interface) of the second user. Also for example, the processing module 41 may automatically publish the advertisement in an event on an area of a profile that includes a news feed. In another embodiment, the processing module 41 may publish the advertisement as described above responsive to a request for the user profile.

The method 250 may further commence at operation 254 with the client machine 20 associated with the third user requesting an interface associated with the second user. At operation 256, the network-based social platform 13 may receive the request and at operation 258 the network-based social platform 13 may communicate the user interface associated with the second user to the client machine 20. At operation 260, the client machine 20 may display the user interface containing the advertisement to the third user.

The method 250 may further commence at operation 262 with the client machine 20 communicating a message with the advertisement to another user. For example, the second user may generate a message by selecting the advertisement on a user interface associated with the second user and dragging the advertisement to the message.

At operation 264, the network-based social platform 13 may receive the message and at operation 266 the network-based social platform 13 may communicate the message to the recipient. At operation 268, the client machine 20 associated with a third user, may receive and display the message containing the advertisement.

In one embodiment the message may include an email message addressed to an inbox outside of the network-based social platform 13. In another embodiment, the message may include a network-based social platform 13 message addressed to inbox on the network-based social platform 13. In yet another embodiment, the message may include a “poke” message addressed to a user with the designation of “friend” on the network-based social platform 13.

The method 250 may further commence at operation 270 with the second user at the client machine 20 requesting the advertisement be posted on a user interface. For example, the second user may select the advertisement from a user interface (e.g., user profile of the second user) and drag the advertisement to another area of the user interface or another user interface (e.g., user profile of a different user). At operation 272, at the network-based social platform 13, the processing module 41 receives the request to post the advertisement and at operation 274 the processing module 41 posts the advertisement to the user interface as requested.

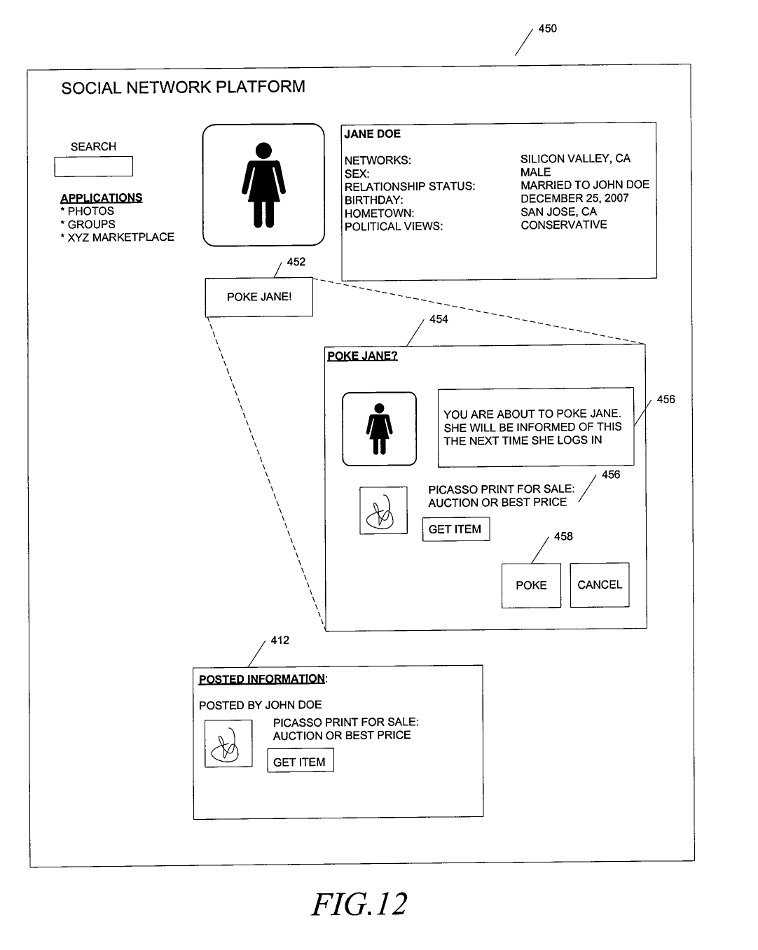

FIG. 10 is a block diagram illustrating a method 300, according to an embodiment, to receive a selection that results in a sale of an item. Illustrated on the middle left may be operations performed on a client machine 20 associated with a third user and illustrated on the far right may be operations performed on a client machine 20 associated with a second user. For example, the second user may have accepted an agreement to promote an advertisement authored by a first user in exchange for compensation resulting from a sale of an item based on the advertisement. Further for example, the third user may be a user on the network-based social platform 13 that views the advertisement and acquires an item for sale based on the advertisement. Illustrated on the middle right may be operations performed on a network-based social platform 13 and illustrated on the far left may be operations performed on a network-based marketplace 12.

The method may commence with the client machine 20 associated with the third user communicating a selection of the third user. Specifically, the client machine 20 may be communicating a selection of an item for sale that appears on an advertisement.

At operation 304, at the network-based social platform 13, the communication module 39 receives the selection and at operation 306 the processing module 41 communicates the selection of the item, an identifier of the third user, and an identifier of the second user to the network-based marketplace 12.

At operation 308, the network-based marketplace 12 receives the item selection and the identifiers and at operation 310 communicates a listing of the item to the client machine 20 associated with the third user. The listing may include item information 176 enabling the third user to submit a winning bid in an auction or a purchase price for immediate purchase of the item. At operation 310, the client machine 20 communicates a winning bid or an acceptance to pay a purchase price for the item to the network-based marketplace 12.

At operation 312, the network-based marketplace 12 receives the winning bid or the acceptance to pay the purchase price for the item and at operation 314 the network-based marketplace communicates compensation that may be accessed via the client machine 20 associated with the first user, as indicated by the broken line. For example, the first user may receive an electronic deposit in a checking account or some other electronic account (e.g., credit, debit, etc.) that is accessible to the client machine 20. In yet another embodiment, the first user may receive a check that is mailed on a periodic basis.

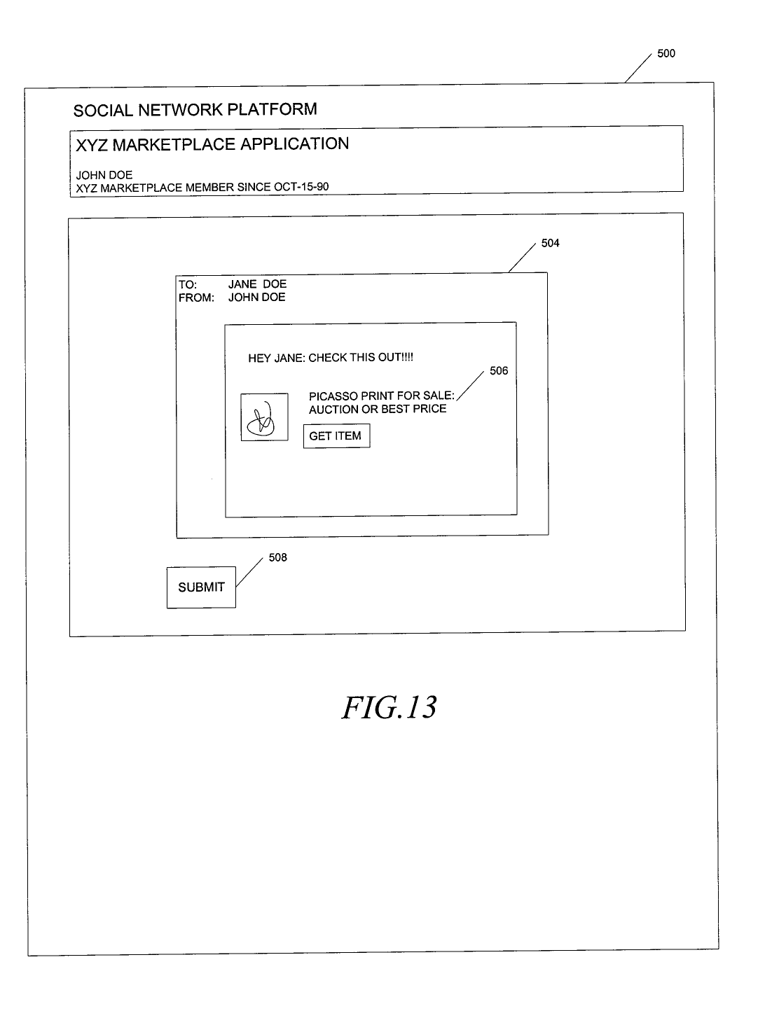

FIG. 11 is a diagram illustrating a user interface 400, according to an embodiment, of a user profile. The user profile may include user profile information 42 for the user featured by the user profile. The user profile may be displayed by the network-based social platform 13 to the user featured by the profile on the client machines 20, 22. A portion or all of the user profile information 42 may also be displayed to others users on the network-based social platform 13 according to a relationship with the user featured by the profile. The user interface 400 may include an input box 402 to enter keywords that may be used to search the network-based social platform 13, a user interface element 403 to launch the XYZ marketplace application, user status information 404, advertisement information 406, related user information 408, event information 410 and posted information 412.

The status information 404 includes information about the user that is featured by the user profile. The event information 410 may include events that are automatically published by the network-based social platform 13. The events may chronicle actions performed by the user associated with the profile (e.g., John Doe) or actions performed by other users (e.g., “marketplace community member”, “friend,” “favorite friend,” etc.) on the network-based social platform 13. The event information 410 includes an event 416 that includes an advertisement for a Picasso print (e.g., item). The event 416 may be automatically published responsive to the user “John Doe” accepting an agreement, as previously described, with another user that is selling the Picasso print. The event 416 includes a user interface element 418 that may be selected by a user of the network-based social platform to receive additional information about the Picasso print and to enter a winning bid for the item or accept a purchase price for the item.

The related user information 408 may include information about other users that are related (e.g., “friends”) to the user featured by the profile. The posted information 412 may include content posted by the user associated with the profile (e.g., “John Doe”). Accordingly, the posted information 412 enables the user to share content with other users on the network-based social platform 13. For example, posted content may include advertisements, websites, blogs, videos, and songs. Posted content may also include content from the network-based social platform 13 including profiles, photos, notes, groups, and events. In one embodiment content may be posted by copying and pasting a URL, selecting a share button located on user interfaces of the network-based social platform 13. The posted information 412 is shown to include an advertisement for the Picasso print, as previously described. The advertisement information 406 may include an advertisement automatically published responsive to the user “John Doe” accepting an agreement, as previously described, with another user that is selling the Picasso print.

FIG. 13 is a diagram illustrating a user interface 450, according to an embodiment, of a user profile of a user as viewed by a different user. For example, the user interface 450 may be for “Jane Doe” as viewed by “John Doe.” The user interface 450 includes a user interface element 452 that may be selected to generate a dialogue box 454 to “poke” “Jane Doe.” A “poke” may be a message that appears to a user in response to the user signing on to the network-based social platform 13. The dialogue box 454 is shown to include a text string 456 describing the present “poke” and an advertisement 456. The advertisement may be placed in the dialogue box 454 by a user before sending the “poke.” For example, “John Doe” may have selected the advertisement from his profile and dropped the advertisement into the dialogue box 454 for inclusion in the “poke.” Responsive to selection of a user interface element 458, the “poke,” including the advertisement, may be registered for “Jane Doe” and appear to her the next time she signs on to the network-based social platform 13.

The user interface 450 further includes posted information 412 as previously described. The posted information 412 is shown to include an advertisement identifying the user (e.g., “John Doe”) who posted the advertisement.

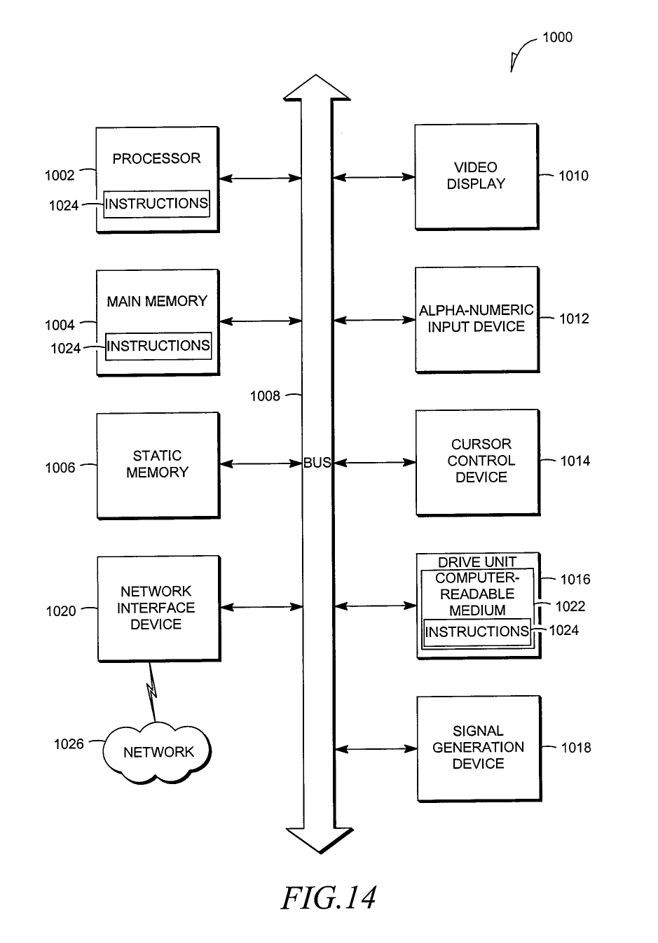

FIG. 14 is a diagram illustrating a user interface 500, according to an embodiment, to author a message. For example, the user interface 500 may be utilized to author a message 504 for communicating over the network-based social platform 13 to another user. The message 504 is shown to include an advertisement 506 that may have been dropped into the message 504 by the sender. For example, “John Doe” may have selected the advertisement from his profile and dropped the advertisement into the message 504. Responsive to selection of a user interface element 508, the message 504, including the advertisement 506, may be communicated to “Jane Doe.”

FIG. 17 is a diagrammatic representation of a machine in the example form of a computer system 1000 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU) a graphics processing unit (GPU) or both), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a cursor control device 1014 (e.g., a mouse), a disk drive unit 1016, a signal generation device 1018 (e.g., a speaker) and a network interface device 1020.

The disk drive unit 1016 includes a machine-readable medium 1022 on which is stored one or more sets of instructions (e.g., software 1024) embodying any one or more of the methodologies or functions described herein. The software 1024 may also reside, completely or at least partially, within the main memory 1004 and/or within the processor 1002 during execution thereof by the computer system 1000, the main memory 1004 and the processor 1002 also constituting machine-readable media.

The software 1024 may further be transmitted or received over a network 1026 via the network interface device 1020.

While the machine-readable medium 1022 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure. The term “machine-readable medium” shall accordingly be taken to include, but not be limited to, solid-state memories, optical and magnetic media, and carrier wave signals.

### A Three-Tier Architecture

In some embodiments, a method is illustrated as implemented in a distributed or non-distributed software application designed under a three-tier architecture paradigm, whereby the various components of computer code that implement this method may be categorized as belonging to one or more of these three tiers. Some embodiments may include a first tier as an interface (e.g., an interface tier) that is relatively free of application processing. Further, a second tier may be a logic tier that performs application processing in the form of logical/mathematical manipulations of data inputted through the interface level, and communicates the results of these logical/mathematical manipulations to the interface tier, and/or to a backend, or storage tier. These logical/mathematical manipulations may relate to certain business rules, or processes that govern the software application as a whole. A third, storage tier, may be a persistent storage medium or, non-persistent storage medium. In some cases, one or more of these tiers may be collapsed into another, resulting in a two-tier architecture, or even a one-tier architecture. For example, the interface and logic tiers may be consolidated, or the logic and storage tiers may be consolidated, as in the case of a software application with an embedded database. This three-tier architecture may be implemented using one technology, or, as will be discussed below, a variety of technologies. This three-tier architecture, and the technologies through which it is implemented, may be executed on two or more computer systems organized in a server-client, peer to peer, or so some other suitable configuration. Further, these three tiers may be distributed between more than one computer system as various software components.

### Modules, Components and Logic

Certain embodiments are described herein as including logic or a number of modules, components or mechanisms. A module, logic, component or mechanism (herein after collectively referred to as a “module”) may be a tangible unit capable of performing certain operations and is configured or arranged in a certain manner. In example embodiments, one or more computer systems (e.g., a standalone, client or server computer system) or one or more components of a computer system (e.g., a processor or a group of processors) may be configured by software (e.g., an application or application portion) as a “module” that operates to perform certain operations as described herein.

In various embodiments, a “module” may be implemented mechanically or electronically. For example, a module may comprise dedicated circuitry or logic that is permanently configured (e.g., within a special-purpose processor) to perform certain operations. A module may also comprise programmable logic or circuitry (e.g., as encompassed within a general-purpose processor or other programmable processor) that is temporarily configured by software to perform certain operations. It will be appreciated that the decision to implement a module mechanically, in the dedicated and permanently configured circuitry, or in temporarily configured circuitry (e.g., configured by software) may be driven by cost and time considerations.

Accordingly, the term “module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiple of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, a one module may perform an operation, and store the output of that operation in a memory device to which it is communicatively coupled. A further module may then, at a later time, access the memory device to retrieve and process the stored output. Modules may also initiate communications with input or output devices, and can operate on a resource (e.g., a collection of information).

### Component Design

Some example embodiments may include the above illustrated tiers, and processes or operations that make them up, as being written as one or more software components. Common too many of these components is the ability to generate, use, and manipulate data. These components, and the functionality associated with each, may be used by client, server, or peer computer systems. These various components may be implemented by a computer system on an as-needed basis. These components may be written in an object-oriented computer language such that a component oriented, or object-oriented programming technique can be implemented using a Visual Component Library (VCL), Component Library for Cross Platform (CLX), Java Beans (JB), Java Enterprise Beans (EJB), Component Object Model (COM), Distributed Component Object Model (DCOM), or other suitable technique. These components may be linked to other components via various Application Programming interfaces (APIs), and then compiled into one complete server, client, and/or peer software application. Further, these APIs may be able to communicate through various distributed programming protocols as distributed computing components.

### Distributed Computing Components and Protocols

Some example embodiments may include remote procedure calls being used to implement one or more of the above illustrated components across a distributed programming environment as distributed computing components. For example, an interface component (e.g., an interface tier) may reside on a first computer system that is remotely located from a second computer system containing a logic component (e.g., a logic tier). These first and second computer systems may be configured in a server-client, peer-to-peer, or some other suitable configuration. These various components may be written using the above illustrated object-oriented programming techniques, and can be written in the same programming language, or a different programming language. Various protocols may be implemented to enable these various components to communicate regardless of the programming language used to write these components. For example, an component written in C++ may be able to communicate with another component written in the Java programming language through utilizing a distributed computing protocol such as a Common Object Request Broker Architecture (CORBA), a Simple Object Access Protocol (SOAP), or some other suitable protocol. Some embodiments may include the use of one or more of these protocols with the various protocols outlined in the OSI model, or TCP/IP protocol stack model for defining the protocols used by a network to transmit data.

### A System of Transmission Between a Server and Client

Some embodiments may utilize the OSI model or TCP/IP protocol stack model for defining the protocols used by a network to transmit data. In applying these models, a system of data transmission between a server and client, or between peer computer systems is illustrated as a series of roughly five layers comprising: an application layer, a transport layer, a network layer, a data link layer, and a physical layer. In the case of software having a three tier architecture, the various tiers (e.g., the interface, logic, and storage tiers) reside on the application layer of the TCP/IP protocol stack. In an example implementation using the TCP/IP protocol stack model, data from an application residing at the application layer is loaded into the data load field of a TCP segment residing at the transport layer. This TCP segment also contains port information for a recipient software application residing remotely. This TCP segment is loaded into the data load field of an IP datagram residing at the network layer. Next, this IP datagram is loaded into a frame residing at the data link layer. This frame is then encoded at the physical layer, and the data transmitted over a network such as an internet, Local Area Network (LAN), Wide Area Network (WAN), or some other suitable network. In some cases, internet refers to a network of networks. These networks may use a variety of protocols for the exchange of data, including the aforementioned TCP/IP, and additionally ATM, SNA, SDI, or some other suitable protocol. These networks may be organized within a variety of topologies (e.g., a star topology), or structures.

The Abstract of the Disclosure is provided to comply with 37 C.F.R. §1.72(b), requiring an abstract that may allow the reader to quickly ascertain the nature of the technical disclosure. It is submitted with the understanding that it may not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. A method comprising:
at a network-based social platform,
receiving a request from a first user of the network-based social platform to request a second user of the network-based social platform to accept an agreement to facilitate promotion of an advertisement in association with the second user on the network-based social platform, the advertisement to facilitate a sale of at least one item offered for sale by the first user on a network-based marketplace;
receiving an acceptance of the agreement from the second user to facilitate promotion of the advertisement in association with the second user on the network-based social platform; and
promoting the advertisement in association with the second user on the network-based social platform.

2. The method of claim 1, further comprising receiving the advertisement.

3. The method of claim 1, wherein the advertisement is selected from a group of advertisements consisting of an item for sale advertisement, a plurality of items for sale advertisement, a virtual store advertisement, and a category of items for sale advertisement.

4. The method of claim 1, wherein the promoting the advertisement includes the network-based social platform automatically publishing the advertisement on an area of an interface associated with the second user.

5. The method of claim 4, wherein the area of the interface includes a news feed.

6. The method of claim 1, wherein the promoting the advertisement includes receiving from the second user a message for communicating over the network-based social platform to another user, wherein the message includes the advertisement and is selected from a group of messages consisting of a poke message, an email message, and a network-based social platform message.

7. The method of claim 1, wherein the promoting the advertisement includes receiving from the second user a request to post the advertisement on a user interface associated with a third user.

8. The method of claim 7, wherein the user interface includes an area to publish the advertisement.

9. The method of claim 1, further comprising receiving a selection based on the advertisement from a third user on the network-based social platform that results in a sale of at least one item offered for sale by the first user on the network-based marketplace and a payment of a predetermined compensation from the first user to the second user.

10. A system comprising:
at a network-based social platform,
a communication module to receive a request from a first user of the network-based social platform to request a second user of the network-based social platform to accept an agreement to facilitate promotion of an advertisement in association with the second user on the network-based social platform, the advertisement to facilitate a sale of at least one item offered for sale by the first user on a network-based marketplace, the communication module to receive an acceptance of the agreement from the second user to facilitate promotion of the advertisement in association with the second user on the network-based social platform; and
a processing module to promote the advertisement in association with the second user on the network-based social platform.

11. The system of claim 10, wherein the communication module is to receive the advertisement.

12. The system of claim 10, wherein the advertisement is selected from a group of advertisements consisting of an item for sale advertisement, a plurality of items for sale advertisement, a virtual store advertisement, and a category of items for sale advertisement.

13. The system of claim 10, wherein the processing module is to automatically publish the advertisement on an area of an interface associated with the second user.

14. The system of claim 13, wherein the area of the interface includes a news feed.

15. The system of claim 10, wherein the network-based social platform is to receive a message from the second user and to communicate the message to another user, wherein the message includes the advertisement and is selected from a group of messages consisting of a poke message, an email message, and a network-based social platform message.

16. The system of claim 10, wherein the communication module is to receive a request from the second user to post the advertisement on a user interface associated with a third user.

17. The system of claim 16, wherein the user interface includes an area to publish the advertisement.

18. The system of claim 10, wherein the communication module is to receive a selection based on the advertisement from a third user on the network-based social platform that results in a sale of at least one item offered for sale by the first user on the network-based marketplace and a payment of a predetermined compensation from the first user to the second user.

19. A machine-readable medium storing instructions that, when executed by a machine, cause the machine to:
receive a request from a first user of the network-based social platform to request a second user of the network-based social platform to accept an agreement to facilitate promotion of an advertisement in association with the second user on the network-based social platform, the advertisement to facilitate a sale of at least one item offered for sale by the first user on a network-based marketplace;
receive an acceptance of the agreement from the second user to facilitate promotion of the advertisement in association with the second user on the network-based social platform; and
promote the advertisement in association with the second user on the network-based social platform.

20. A system comprising:
at a network-based social platform,
a first means for receiving a request from a first user of the network-based social platform to request a second user of the network-based social platform to accept an agreement to facilitate promotion of an advertisement in association with the second user on the network-based social platform, the advertisement to facilitate a sale of at least one item offered for sale by the first user on a network-based marketplace, the first means for receiving an acceptance of the agreement from the second user to facilitate promotion of the advertisement in association with the second user on the network-based social platform; and
a second means for promoting the advertisement in association with the second user on the network-based social platform.

21. A method comprising:
receiving a first selection from a user of a network-based social platform, the selection includes an acceptance of an agreement to facilitate promotion of a virtual store advertisement on the network-based social platform, the virtual store advertisement includes an advertisement of a virtual store that is hosted by a network-based marketplace;
publishing the virtual store advertisement on the network-based social platform on an interface that identifies the user of the network-based social platform; and
receiving a second selection that identifies the virtual store advertisement on the interface, the receiving the second selection resulting in a sale of an item offered for sale on the network-based marketplace.

22. The method of claim 21, further comprising receiving the virtual store advertisement.

23. The method of claim 21, wherein the publishing the virtual store advertisement includes publishing the virtual store advertisement in a news feed on the interface.

24. A system comprising:
at least one machine to execute:
a communication module to receiving a first selection from a user of a network-based social platform, the selection includes an acceptance of an agreement to facilitate promotion of a virtual store advertisement on the network-based social platform, the virtual store advertisement includes an advertisement of a virtual store that is hosted by a network-based marketplace; and
a processing module to publish the virtual store advertisement on the network-based social platform on an interface that identifies the user of the network-based social platform; the communication module to receive a second selection that identifies the virtual store advertisement on the interface, the second selection results in a sale of an item offered for sale on the network-based marketplace.

25. The method of claim 24, wherein the communication module further receives the virtual store advertisement.

26. The method of claim 21, wherein the publishing module is to publish the virtual store advertisement in a news feed on the interface.

27. A machine-readable medium storing instructions that, when executed by a machine, cause the machine to:
receive a first selection from a user of a network-based social platform, the selection includes an acceptance of an agreement to facilitate promotion of a virtual store advertisement on the network-based social platform, the virtual store advertisement includes an advertisement of a virtual store that is hosted by a network-based marketplace;
publish the virtual store advertisement on the network-based social platform on an interface that identifies the user of the network-based social platform; and
receive a second selection that identifies the virtual store advertisement on the interface, the second selection to result in a sale of an item offered for sale on the network-based marketplace.
